(19) United States
(12) Patent Application Publication
(10) Pub. No.: US 2003/0072958 A1
(43) Pub. Date: Apr. 17, 2003

(54) Resin sheet, thermoformed resin article, and laminate structure

(75) Inventors: Kenichi Higashi, Sodegaura-shi (JP); Nobuo Oi, Narashino-shi (JP)

Correspondence Address: SUGHRUE MION, PLLC, 2100 Pennsylvania Avenue, NW, Washington, DC, 20037-3213, US

(73) Assignee: SUMITOMO CHEMICAL COMPANY, LIMITED

(21) Appl. No.: 10/254,655

(22) Filed: Sep. 26, 2002

(30) Foreign Application Priority Data
Sep. 28, 2001 (JP) 2001-302911

(51) Int. Cl. B32B 27/08

(52) U.S. Cl. 428/518; 428/523

(57) ABSTRACT

Disclosed is a resin sheet having a resin layer comprising a copolymer of ethylene and/or α-olefin and a vinyl compound (I) defined below or a vinyl compound (II) defined below:

Vinyl compound (I): A vinyl compound represented by CH₂═CH.R, wherein the substituent R has a steric parameter Es of not larger than −1.64 and a steric parameter B1 of not smaller than 1.53;

Vinyl compound (II): A vinyl compound represented by CH₂═CH.R′, wherein the substituent R′ is a secondary alkyl group or a tertiary alkyl group.

### BACKGROUND OF THE INVENTION

1. Field of the Invention

The present invention relates to an olefin-based resin sheet suitable for use in thermoforming and to a thermoformed resin article and a laminate structure which are produced by use of the olefin-based resin sheet.

2. Description of Related Art

For preventing a surface of a molded article from being scratched and at the same time imparting design to the molded article in injection molding or injection compression molding (henceforth, abbreviated “injection molding”) of a thermoplastic resin, known is an approach in which a decorated laminate structure is obtained by first preparing a thermoformed article by thermoforming a decoration sheet into a desired shape, setting the thermoformed article into a mold and subsequently injecting a molten resin, thereby performing lamination molding. Development of decoration sheets that can be adhered well to a surface of a substrate made of an olefin-based resin and realizing impartment of both scratch resistance and design has recently been pursued especially with increase of demand for molded articles comprising an olefin-based resin.

For example, Japanese Patent Unexamined Publications 9-193189 and 9-234836 and Japanese Patent Examined Publications 6-26718 and 8-2550 disclose sheets for thermoforming. In the sheets an acrylic resin, which is highly transparent and hard, is disposed to form an outermost layer. Resin molded articles are expected to have recyclability from recent increase of environmental sensitivity. However, even if you try to recycle a laminate structure decorated with a sheet, containing an acrylic resin as an essential material, for thermoforming, it is difficult to separate the acrylic resin from an olefin-based resin and, therefore, it is difficult to recycle such a laminate structure. On the other hand, a sheet for thermoforming, the sheet being designed in consideration of recyclability and being made of an olefin-based resin, has an insufficient scratch resistance.

### SUMMARY OF THE INVENTION

An object of the present invention is to provide a resin sheet suitable for thermoforming wherein the resin sheet is made of an olefin-based resin and is excellent in scratch resistance.

Another object of the present invention is to provide a thermoformed resin article made of an olefin-based resin, the article being excellent in scratch resistance.

Another object of the present invention is to provide a laminate structure excellent in scratch resistance wherein the surface of the laminate structure is formed of a thermoformed resin article which is made of an olefin-based resin and which is excellent in scratch resistance.

The present invention relates to a resin sheet suitable for thermoforming, the resin sheet having a resin layer comprising a copolymer of ethylene and/or α-olefin and a vinyl compound (I) defined below or a vinyl compound (II) defined below, and to a thermoformed resin article obtained by thermoforming the foregoing resin sheet. The present invention relates also to a laminate structure obtained by laminating the thermoformed article and a substrate comprising a thermoplastic resin.

Vinyl compound (I): A vinyl compound represented by CH₂═CH.R, wherein the substituent R has a steric parameter Es of not larger than −1.64 and a steric parameter B1 of not smaller than 1.53.

Vinyl compound (II): A vinyl compound represented by CH₂═CH.R′, wherein the substituent R′ is a secondary alkyl group or a tertiary alkyl group.

Films and sheets are generally distinguished from each other based on their thickness. In the present invention, however, these are generically called sheets.

### BRIEF DESCRIPTION OF THE DRAWINGS

FIG. 1 is a plan view of a structure having a laminate film laminated. 1, 2, 3 and 4 represent a gate, a pencil hardness measurement position, a laminate film and a substrate, respectively.

### DESCRIPTION OF PREFERRED EMBODIMENTS

Preferred as the α-olefin used in the present invention are α-olefins having from 3 to 20 carbon atoms. Specific examples of such α-olefins include linear olefins such as propylene, 1-butene, 1-pentene, 1-hexene, 1-heptene, 1-octene, 1-nonene and 1-decene, branched olefins such as 3-methylbutene-1, 3-methyl-1-pentene, 4-methyl-1-pentene and 5-methyl-1-hexene, etc. A more preferable α-olefin is propylene, 1-butene, 1-pentene, 1-hexene, 1-octene or 4-methyl-1-pentene. Especially preferred is propylene, 1-butene or 1-hexene.

The vinyl compound used in the present invention is a vinyl compound having a bulky substituent. In the present invention may be used a vinyl compound (I) defined below:

Vinyl compound (I): A vinyl compound represented by CH₂═CH.R, wherein the substituent R has a steric parameter Es of not larger than −1.64 and a steric parameter B1 of not smaller than 1.53.

The steric parameters Es and B1 used herein are parameters that indicate how sterically bulky a substituent is; Es indicates the three-dimensional expansion and B1 indicates the two-dimensional expansion. The parameters are determined by the method described in a paper, C. Hansch and A. Leo: “Exploring QSAR Fundamentals and Applications in Chemistry and Biology” Chapter 3 (ACS Professional Reference Book, Washington, D.C. (1995).

Examples of the vinyl compound (I) are tabulated below.

| Name of compound | Es | B1 |
|---|---|---|
| 3-Methyl-1-butene | −1.71 | 1.90 |
| 3-Methyl-1-pentene | −2.37 | 1.90 |
| Vinylcyclopentane | −1.75 | 1.90 |
| Vinylcyclohexane | −1.81 | 1.91 |
| 4,4-Dimethyl-1-pentene | −2.91 | 2.47 |
| 3-Ethyl-pentene | −3.12 | 2.13 |
| 3,3-Dimethyl-1-butene | −2.78 | 2.60 |
| 3,3-Dimethyl-1-pentene | −3.40 | 2.60 |
| 3,3,5-Trimethyl-1-hexene | −3.09 | 1.90 |
| 3,4-Dimethyl-1-pentene | −3.05 | 1.90 |
| 3,4,4-Trimethyl-1-pentene | −4.57 | 1.90 |
| 3-Ethyl-4-methyl-1-pentene | −4.35 | 1.90 |
| 3,3-Dimethyl-4-methyl-1-pentene | −4.66 | 2.60 |

For reference, tabulated below are steric parameters of several vinyl compounds having a substituent that is not bulky.

| Name of compound | Es | B1 |
|---|---|---|
| Propylene | −1.24 | 1.52 |
| 1-Butene | −1.31 | 1.52 |
| 1-Octene | −1.54 | 1.52 |
| Styrene | −1.01 | 1.71 |

In the present invention, vinyl compounds having a more bulky substituent are employed more suitably. The steric parameter Es of the substituent R is preferably from −4.65 to −1.70, more preferably from −3.00 to −1.72, especially preferably from −2.80 to −1.75, and most preferably from −2.10 to −1.75. The steric parameter B1 of the substituent R is preferably from 1.53 to 2.90, more preferably from 1.70 to 2.70, and especially preferably from 1.91 to 2.30. Properties of copolymers obtained will be described. A too large steric parameter Es or a too small steric parameter B1 adversely results in poor elasticity recovering ability or poor delayed recovering ability.

In the present invention, a vinyl compound (I) in which the substituent R is a hydrocarbon group is suitable. A vinyl compound (I) in which the substituent R is a saturated hydrocarbon group is more suitable.

The vinyl compound (I) used in the present invention preferably has a branched structure only at the carbon atom of the 3-position. The branched structure referred to herein is a structure that contains no straight-chain molecular skeleton and contains a skeleton that branches through a tertiary or quaternary carbon atom. Such a vinyl compound is synthesized more easily than vinyl compounds having two or more branched structures.

Vinyl compounds in which the carbon atom of the 3-position is a tertiary or quaternary carbon atom and only the carbon atom of the 3-position has a branched structure are more preferable as the vinyl compound (I) to be used in the present invention.

The vinyl compound having a bulky substituent to be used in the present invention is, from another viewpoint, a vinyl compound (II) defined below:

Vinyl compound (II): A vinyl compound represented by CH₂═CH.R′, wherein the substituent R′ is a secondary alkyl group or a tertiary alkyl group.

Preferred as the secondary or tertiary alkyl group referred to herein are secondary alkyl groups having from 3 to 20 carbon atoms or tertiary alkyl groups having from 4 to 20 carbon atoms. R may be a cycloalkyl group and, in this case, is preferably a 3- to 6-membered cycloalkyl group, more preferably a 3- to 10 cycloalkyl group having from 3 to 20 carbon atoms. Preferred as R′ are 3- to 10-membered cycloalkyl groups having from 3 to 20 carbon atoms or tertiary alkyl groups having from 4 to 20 carbon atoms.

Specific examples of such vinyl compound (II) include vinylcyclopropane, vinylcyclobutane, vinylcyclopentane, vinylcyclohexane, vinylcycloheptane, vinylcyclooctane, 3-methyl-1-butene, 3-methyl-1-pentene, 3-methyl-1-hexene, 3-methyl-1-heptene, 3-methyl-1-octene, 3,3-dimethyl-1-butene, 3,3-dimethyl-1-pentene, 3,3-dimethyl-1-hexene, 3,3-dimethyl-1-heptene, 3,3-dimethyl-1-octene, 3,4-dimethyl-1-pentene, 3,4-dimethyl-1-hexene, 3,4-dimethyl-1-heptene, 3,4-dimethyl-1-octene, 3,5-dimethyl-1-hexene, 3,5-dimethyl-1-heptene, 3,5-dimethyl-1-octene, 3,6-dimethyl-1-heptene, 3,6-dimethyl-1-octene, 3,7-dimethyl-1-octene, 3,3,4-trimethyl-1-pentene, 3,3,4-trimethyl-1-hexene, 3,3,4-trimethyl-1-heptene, 3,3,4-trimethyl-1-octene, 3,4,4-trimethyl-1-pentene, 3,4,4-trimethyl-1-hexene, 3,4,4-trimethyl-1-heptene, 3,4,4-trimethyl-1-octene, 5-vinyl-2-norbornene, 1-vinyladamantane, 4-vinyl-1-cyclohexene, etc.

A more preferable vinyl compound (II) is vinylcyclopentane, vinylcyclohexane, vinylcycloheptane, vinylcyclooctane, 5-vinyl-2-norbornene, 3-methyl-1-butene, 3-methyl-1-pentene, 3-methyl-1-hexene, 3,3-dimethyl-1-butene, 3,3-dimethyl-1-pentene, 3,4-dimethyl-1pentene, 3,5-dimethyl-1-hexene, 3,3,4-trimethyl-1-pentene, or 3,4,4-trimethyl-1-pentene. A more preferable vinyl compound (II) is vinylcyclohexane, vinylnorbornene, 3-methyl-1-butene, 3-methyl-1-pentene, 3,3-dimethyl-1-butene, 3,4-dimethyl-1-pentene or 3,3,4-trimethyl-1-pentene. An especially preferable vinyl compound (II) is vinylcyclohexane or 3,3-dimethyl-1-butene.

The copolymer used in the present invention may be that obtained by copolymerizing ethylene and/or α-olefin and a vinyl compound having a bulky substituent and also additional one or more addition-polymerizable monomers. Examples of the addition-polymerizable monomer include cyclic olefins having from 3 to 20 carbon atoms, vinylidene compounds, diene compounds or other vinyl compounds.

Specific examples of such cyclic olefins include cyclobutene, cyclopentene, cyclohexene, cyclooctene, 3-methylcyclopentene, 4-methylcyclopentene, 3-methylcyclohexene, 2-norbornene, 5-methyl-2-norbornene, 5-ethyl-2-norbornene, 5-butyl-2-norbornene, 5-phenyl-2-norbornene, 5-benzyl-2-norbornene, 2-tetracyclododecene, 2-tricyclodecene, 2-tricycloundecene, 2-pentacyclopentadecene, 2-pentacyclohexadecene, 8-methyl-2-tetracyclododecene, 8-ethyl-2-tetracyclododecene, 5-acetyl-2-norbornene, 5-acetyloxy-2-norbornene, 5-methoxycarbonyl-2-norbornene, 5-ethoxycarbonyl-2-norbornene, 5-methyl-5-methoxycarbonyl-2-norbornene, 5-cyano-2-norbornene, 8-methoxycarbonyl-2-tetracyclododecene, 8-methyl-8-methoxycarbonyl-2-tetracyclododecene, 8-cyano-2-tetracyclododecene, etc. A more preferable cyclic olefin is cyclopentene, cyclohexene, cyclooctene, 2-norbornene, 5-methyl-2-norbornene, 5-phenyl-2-norbornene, 2-tetracyclododecene, 2-tricyclodecene, 2-tricycloundecene, 2-pentacyclopentadecene, 2-pentacyclohexadecene, 5-acetyl-2-norbornene, 5-acetyloxy-2-norbornene, 5-methoxycarbonyl-2-norbornene, 5-methyl-5-methoxycarbonyl-2-norbornene, or 5-cyano-2-norbornene, Especially preferred is 2-norbornene or 2-tetracyclododecene.

Specific examples of the aforementioned vinylidene compounds include isobutene, 2-methyl-1-butene, 2-methyl-1-pentene, 2-methyl-1-hexene, 2-methyl-1-heptene, 2-methyl-1-octene, 2,3-dimethyl-1-butene, 2,3-dimethyl-1-pentene, 2,3-dimethyl-1-hexene, 2,3-dimethyl-1-heptene, 2,3-dimethyl-1-octene, 2,4-dimethyl-1-pentene, 2,4,4-trimethyl-1-pentene, etc. An especially preferable vinylidene compound is isobutene, 2,3-dimethyl-1-butene or 2,4,4-trimethyl-1-pentene.

Specific examples of the aforementioned diene compounds include 1,3-butadiene, 1,4-pentadiene, 1,5-hexadiene, 1,6-heptadiene, 1,7-octadiene, 1,5-cyclooctadiene, 2,5-norbornadiene, dicyclopentadiene, 5-vinyl-2-norbornene, 5-allyl-2-norbornene, 4-vinyl-1-cyclohexene, 5-ethylidene-2-norbornene, etc. An especially preferable diene compounds is 1,4-pentadiene, 1,5-hexadiene, 2,5-norbornadiene, dicyclopentadiene, 5-vinyl-2-norbornene, 4-vinyl-1-cyclohexene or 5-ethylidene-2-norbornene.

Specific examples of other vinyl compounds include methyl vinyl ether, ethyl vinyl ether, acrylic acid, methyl acrylate, ethyl acrylate, methyl methacrylate, acrylonitrile, vinyl acetate, etc. One or two kinds of them are preferably used.

In the copolymer used in the present invention, the copolymerization composition of the vinyl compound having a bulky substituent may range widely as wide as from 0.1 to 99 mol %. The copolymerization composition of the vinyl compound is preferably from 1 to 90 mol %, more preferably from 5 to 90 mol %, still more preferably from 10 to 90 mol %, and especially preferably from 15 to 85 mol %. A too low copolymerization composition of the vinyl compound is unfavorable from the viewpoint of transparency because the copolymer will form crystals derived from chains of ethylene units or α-olefin units in its skeleton. A too high copolymerization composition of the vinyl compound is unfavorable from the viewpoints of transparency and processability because the copolymer will form crystals derived from chains of the vinyl compound units in its skeleton. The copolymerization composition of the vinyl compound can be determined by conventional methods using ¹H-NMR spectrum or ¹³C-NMR spectrum.

The polymer skeleton of the polymer used in the present invention (including, if any, a branched polymer chain in the molecular chain of the polymer) contains secondary and tertiary carbon atoms derived from vinyl compounds having a bulky substituent. In the case of a copolymer of ethylene and a vinyl copolymer having a bulky substituent, secondary carbon atoms derived from ethylene are also present. In the case of a copolymer with α-olefin such as propylene, there also exist secondary and tertiary carbon atoms derived from the α-olefin. According to the sequence in the polymer skeleton, there may exist a structure in which tertiary carbon atoms are separated by one methylene group, a structure in which tertiary carbon atoms are separated two methylene groups, a structure in which tertiary carbon atoms are separated by three methylene groups, or a structure in which tertiary carbon atoms are separated by four or more methylene groups. Such polymer structures are determined by ¹³C-NMR spectrum. The copolymer used in the present invention has, in its skeleton, a structure in which carbon atoms having a substituent R derived from a vinyl compound having a bulky substituent are separated preferably by three methylene groups, and more preferably has a structure in which such carbon atoms are separated by one methylene group. The copolymers having such structures are preferred because of their excellent flexibility.

From the viewpoint of weather resistance, the copolymer used in the present invention preferably contains no double bonds in the whole molecular structure (including the substituent R) of the polymer except the terminals of the copolymer. Copolymers containing double bonds in the molecular structure of the polymers are poor in thermal stability and may cause problems such as generation of fish eyes resulting from gelation occurring during a molding process.

From the viewpoints of mechanical strength and transparency, the copolymer used in the present invention preferably has a molecular weight distribution (Mw/Mn), expressed by a ratio of the weight average molecular weight (Mw) to the number average molecular weight (Mn), of from 1.5 to 4.0, more preferably from 1.5 to 3.5, and especially preferably from 1.5 to 3.0.

From the viewpoint of mechanical strength, the copolymer used in the present invention preferably has a weight average molecular weight of from 8,000 to 1,000,000, more preferably from 10,000 to 500,000, and especially preferably from 30,000 to 400,000.

From the viewpoint of mechanical strength, the copolymer used in the present invention preferably has a limiting viscosity [η] of from 0.2 to 10.0 dl/g, more preferably from 0.25 to 6.0 dl/g, and especially preferably from 0.3 to 5.0 dl/g.

The copolymer used in the present invention is produced, for example, by copolymerizing ethylene and/or α-olefin and a vinyl compound having a bulky substrate in the presence of a catalyst obtained by bringing isopropylidene(cyclopentadienyl)(3-tert-butyl-5-methyl-2-phenoxy)titanium dichloride or isopropylidenebis(indenyl)zirconium dichloride into contact with trityl borate and triisobutyl aluminum, or with methyl almoxane. In the production, optional changes in polymerization conditions such as amounts of feed of α-olefin and the vinyl compound having a bulky substituent, the polymerization temperature, and the polymerization time will result in copolymers of different copolymerization compositions or molecular weights.

In such a production method, a homopolymer of ethylene or a homopolymer of the vinyl compound having a bulky substituent may be by-produced in addition to the aforementioned copolymer depending upon the kind of the catalyst used or the polymerization conditions employed. In such cases, the copolymer can easily be separated by solvent extraction using a Soxhlet's extractor or the like. The solvent used in such extraction may be optionally selected depending upon the kind of the vinyl compound having a bulky substituent. For example, a homopolymer of a vinyl compound having a bulky substituent such as polyvinylcyclohexane can be removed as an insoluble component in an extraction using toluene. Polyethylene can be removed as an insoluble component in an extraction using chloroform. The copolymer can be separated as a soluble component in both the solvents.

The copolymer, of course, may be employed with such by-products held in the copolymer, if no problems arise in its application.

The resin sheet of the present invention has a resin layer made of the aforementioned copolymer. The resin sheet may have a single layer. Alternatively, it may be a multilayer sheet containing at least one resin layer mentioned above. When the sheet for thermoforming of the present invention is a multilayer sheet, it preferably has the aforementioned resin layer as an outermost layer thereof. In such a case, both outermost layers of the multilayer sheet may be the aforementioned resin layer. However, taking the usage pattern in which the sheet is, after its thermoforming, lamination-molded with a substrate comprising a thermoplastic resin into consideration, it is preferable that only one outermost layer is the aforementioned resin layer.

The resin sheet of the present invention is suitably used as a decoration sheet. A thermoformed resin article is obtained by thermoforming the resin sheet of the present invention. Such a thermoformed resin article is suitably used for improving the appearance of a substrate of a thermoplastic resin through lamination molding with the substrate. For example, when a thermoformed resin article prepared from a resin sheet, the sheet having only the aforementioned resin layer with a high transparency is lamination-molded with a colored substrate, the color of the substrate is caused to have a deep feeling. Further, when a thermoformed resin article prepared from a resin sheet having the aforementioned resin layer with high transparency and a design layer having a design such as coloring or print laminated together, is lamination-molded with a substrate, a good surface appearance is imparted to the substrate, in other words, the substrate is decorated, and a deep feeling is imparted to the design.

The resin layer preferably has a total haze of not greater than 10%, and more preferably not greater than 5%. A small total haze is preferred because a thermoformed article obtained by performing thermoforming so that the layer forms a surface or a laminate structure obtained by performing lamination-molding so that a layer derived from that layer forms a surface can show a highly lustering appearance and, if a design layer is contained, a good deep feeling of the design.

When the sheet for thermoforming of the present invention has one or more layers other than the aforementioned resin layer, the total haze of the resin layer is estimated by preparing a sheet under conditions the same as those under which the sheet for thermoforming was performed except for forming no layers other than the resin layer. Alternatively, the total haze is determined by peeling off the resin layer from the multilayer sheet and measuring the total haze of the resin layer peeled.

The resin sheet of the present invention preferably has the aforementioned resin layer and a design layer for achieving an efficient decoration of a substrate. Such a sheet is exemplified by a laminate sheet having two layers, namely, a transparent and a print or colored layer, a laminate sheet having a transparent layer, a print layer and a colored layer, and a laminate sheet having a transparent layer and a print layer and/or a colored layer and a backing layer.

The laminate structure of the present invention is a laminate structure obtained by laminating the above-described thermoformed article and a substrate comprising a thermoplastic resin. Although any known thermoplastic resin may be employed as the thermoplastic resin for forming the substrate, thermoplastic resins which have been used in the fields of automobiles and household appliances are preferably used. More preferably used are crystalline olefin polymer resins.

Such a crystalline olefin polymer resin is a resin comprising an olefin polymer having crystallinity. It is exemplified by a propylene polymer, an ethylene polymer, a 1-butene polymer, etc. and is preferably a propylene polymer. The propylene polymer referred to herein is a polymer obtained by polymerizing propylene and includes a homopolymer of propylene and copolymers obtained by copolymerizing propylene and other comonomer(s) (e.g., ethylene and 1-butene). Random copolymers and block copolymers are conventionally applied for such copolymers. The crystalline olefin polymer resin used in the present invention is preferably a propylene homopolymer, and more preferably a propylene homopolymer having an isotactic pentad fraction of not less than 0.95, and especially preferably a propylene homopolymer having an isotactic pentad fraction of not less than 0.97.

The resin for forming a substrate is preferably a resin capable of adhering easily to a thermoformed article. More preferred is a resin capable of melt-adhering to a thermoformed article. From the viewpoint of adhesiveness between a thermoformed article and a substrate, the resin to form a surface which is adhered to the substrate of the thermoformed article and the resin for forming the substrate are the same resins or similar resins.

The production of the laminate structure of the present invention may be performed in any way using a known method. An example is a method comprising the following steps (1) through (4):

(1) A step of heating and softening the above-described resin sheet;

(2) A step of thermoforming the softened sheet using a mold for thermoforming to obtain a thermoformed resin article;

(3) A step of setting the thermoformed resin article to a cavity die of a mold for molding; and

(4) A step of injecting a molten thermoplastic resin for forming a substrate into the mold in which the thermoformed resin article has been set, thereby obtaining a laminate structure in which the resin injected, which is a substrate, and the thermoformed article have been laminated together.

Examples of the thermoforming method relating to steps (1) and (2) include vacuum forming, air pressure forming, vacuum-pressure forming, etc.

Examples of the molding method relating to step (4) include injection molding, injection compression molding and injection press molding. The temperature of the resin injected in this step is usually not lower than the melting point of the resin, and preferably not lower than 200° C. The temperature of the mold in this step is usually from 20 to 60° C., and preferably from 30 to 40° C. The surface of the mold is preferably smooth. The surface roughness (Ra) is preferably 0.1 μm or less, more preferably 0.08 μm or less, and still more preferably 0.06 μm or less.

Steps (1) through (4) may be performed in one step. For example, the thermoject technique may be employed.

The laminate structure of the present invention, especially that is obtained by laminating a multilayer thermoformed article made from a decorated sheet such as a colored sheet, a grain-patterned sheet, a metallic sheet, and a carbon tone sheet with a substrate is suitably used as an automotive part (interior part or exterior part) such as a center cluster. It is also suitable as a casing part of OA appliances or for applications including parts of household appliances, parts of sundries, signboards, etc.

The various kinds of resins used in the present invention may be used in combination with various kinds of additives, as needed. Examples of the additives include antioxidants, stabilizers, antistatic agents, nucleating agents, adhesives and antifogging agents.

The thickness of the resin sheet of the present invention is usually from 5 to 800 μm, and preferably from 50 to 500 μm.

### EXAMPLES

The present invention will be further described based on examples below. However, the invention is not restricted to the examples.

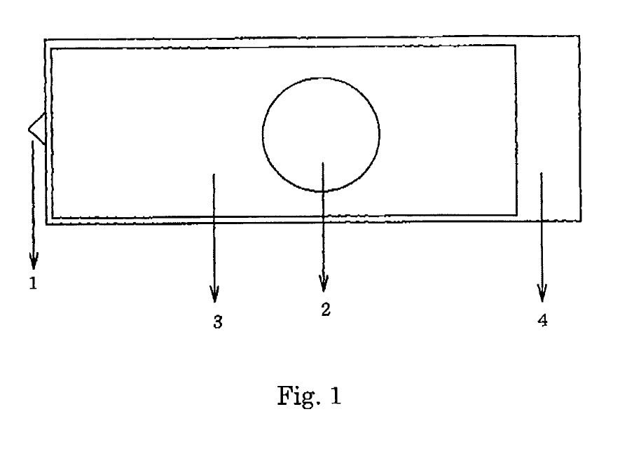

The injection molding machine and the mold used in Examples, the shape of molded articles, evaluation methods and methods for determining properties of polymers are as follows. FIG. 1 is a plan view of a structure having a laminate film laminated. In the drawing, 1, 2, 3 and 4 represent a gate, a pencil hardness measurement position, a laminate film and a substrate, respectively.

(1) Injection Molding Machine and Mold

Injection molding machine FS160S25ASEN manufactured by Nissei Plastic Industry Co., Ltd

Molding temperature: 220° C.

Mold: 150 mm×300 mm×3 mmt, Fan gate

Mold temperature: 40° C.

(2) Evaluation of Scratch Resistance

Evaluation of scratch resistance was performed by measuring the pencil hardness of the surface of a laminate structure according to a pencil scratch test provided in JIS-K-5400. In the evaluation method, a pencil hardness detected when the surface of a structure was damaged first was judged to be the hardness of the structure.

(3) Evaluation of Transparency

As evaluation of transparency, the haze of a film was measured according to a method provided in JIS-K-7105.

(4) Intrinsic Viscosity [η]

The intrinsic viscosity [η] was measured at 135° C. with an Ubbelohde's viscometer using tetralin as a solvent.

(5) Melting Point (Tm) and Glass Transition Point (Tg)

A DSC curve was obtained using a DSC (SSC-5200, manufactured by Seiko Instruments Inc.) under the conditions shown below and a glass transition point was determined from an inflection point of the DSC curve.

Heating: From 20° C. to 200° C. (20° C./min), retention for 10 minutes

Cooling: From 200° C. to −50° C. (20° C./min), retention for 10 minutes

Measurement: From −50° C. to 300° C. (20° C./min)

The molecular weight and the molecular weight distribution were determined using the following two kinds of gel permeation chromatography. The molecular weight distribution was evaluated using the ratio of weight average molecular weight to number average molecular weight (weight average molecular weight/number average molecular weight).

Instrument: 150-CV manufactured by Waters

Column: Shodex 806M/S

Measurement temperature: 145° C.

Measurement solvent: Orthodichlorobenzene

Measurement concentration: 1 mg/ml

(7) Copolymerization Composition and Structure of Polymer

The copolymer composition of the vinylcyclohexane units in a polymer and the structure of the polymer were determined by ¹³C-NMR analysis.

¹³C-NMR apparatus: DRX600 manufactured by Bruker

Measurement solvent: Mixed solution of orthodichlorobenzene and orthodichlorobenzene-d4, 4:1 (volume ratio)

Measurement temperature: 135° C.

(8) Hysteresis Curve

The hysteresis curve of a polymer was obtained under the conditions below with a Strograph-T (manufactured by Toyo Seiki Seisaku-sho, Ltd.).

Test piece: Press sheet sized 120 mm×20 mm×0.3 mm

Tensile speed: 200 mm/min

Tensile magnification: Double

Distance between chucks: 60 mm

(9) Refractive Index

The refractive index of a polymer was investigated by measuring a test piece which was obtained by cutting, into a size of 10 mm×30 mm, a film of 100 μm thickness molded by performing hot-press at 150° C. for 3 minutes under a pressure of 3 to 5 MPa after previously heating at 150° C. for 3 minutes, with an Abbe's refractometer, type 3 (manufactured by Atago Co., Ltd.).

### Example 1

Into a 400 ml autoclave which had been replaced with argon, 102.7 ml of vinylcyclohexane and 43.5 ml dehydrated toluene were charged. After heating to 30° C., ethylene was charged under a pressure of 0.2 MPa. 2.8 ml of a toluene solution of methylalmoxane [MMAO manufactured by Toso-Akzo Co., Ltd.; Concentration in terms of Al atoms: 6 wt %] was charged, and subsequently a solution obtained by dissolving 1.1 mg of isopropylidenebis(indenyl)zirconium dichloride in 1.1 ml of dehydrated toluene was charged. The reaction liquid was stirred for 1 hour and then poured into 500 ml of methanol. A white solid precipitated was collected by filtration. The solid was rinsed with methanol and then dried under reduced pressure to obtain 38.9 g of a polymer. The polymer was subjected to purification by solvent fraction. 2.01 g of a polymer, which is part of the polymer obtained above, was subjected to Soxhlet extraction (for 10 hours) using toluene to obtain 1.99 g of a polymer as a component soluble in toluene. In addition, 1.23 g of a polymer of the resulting toluene-soluble polymer was subjected to Soxhlet extraction (for 10 hours) with chloroform to recover almost the whole polymer as a component soluble in chloroform. The polymer recovered had [η] of 0.39 dl/g, a refractive index of 1.512, a number average molecular weight of 78,000, a molecular weight distribution (weight average molecular weight/number average molecular weight) of 2.0, a glass transition point of 81° C., and a copolymerization composition of vinylcyclohexane of 71 mol %.

The ¹³C-NMR of the resulting polymer confirmed that the polymer has a structure in which carbon atoms having thereon a vinylcyclohexyl group are separated from each other by three methylene groups and a structure in which carbon atoms having thereon a vinylcyclohexyl group are separated from each other by one methylene group.

A film having a thickness of 0.2 mm and an internal haze of 0.3% was produced by pressing the above-obtained polymer at 190° C. with a press molding machine.

While the resulting film was kept in firm contact with a cavity wall of a mold, the mold was closed. Then a thermoplastic resin composition for forming a substrate (a polypropylene resin composition made up of 50 parts by weight of a propylene-ethylene block copolymer, 15 parts by weight of a propylene homopolymer, 14 parts by weight of an ethylene-octene copolymer rubber and 21 parts by weight of talc (average particle size: 2.5 μm)) was injected into the mold to obtain a laminate structure.

The evaluation measurements of the resulting laminate structure are shown in Table 1.

### Comparative Example 1

A film having a thickness of 0.2 mm and an internal haze of 4.8% was produced by pressing, at 190° C. with a press molding machine, a polypropylene resin composition (melting point: 164° C.) obtained by adding 0.3 part by weight of sodium 2,2-methylenebis(4,6-di-tert-butylphenyl) (Adeca Stab NA-21, manufactured by Asahi Denka Co., Ltd.) as a nucleating agent to 100 parts by weight of a propylene homopolymer (Sumitomo Noblene HW100XXG, manufactured by Sumitomo Chemical Co., Ltd.; Limiting viscosity: 1.6 dl/g). From the film obtained, a laminate structure was obtained in a manner the same as that in Example 1. The results are shown in Table 1.

TABLE 1

| | | | | Evaluation of |
|---|---|---|---|---|
| | | | | molded |
| | | | | article |
| | Physical properties of film | | | Scratch |
| | | | Transparency | resistance |
| | Tg | Tm | (Internal haze) | Pencil |
| | ° C. | ° C. | % | hardness |
| Example 1 | 81 | . . . | 0.3 | 2H |
| Comparative | . . . | 164 | 4.8 | H |
| Example 1 | | | | |

According to the present invention, provided is a resin sheet made of an olefin-based resin, the resin sheet being excellent in scratch resistance and being suitable for use in thermoforming. From the resin sheet of the present invention, a thermoformed resin article excellent in transparency, luster feeling and deep feeling can be obtained. The thermoformed resin article is suitably used for wide applications such as automotive parts and parts of household appliances.

What is claimed is:

1. A resin sheet having a resin layer comprising a copolymer of ethylene and/or α-olefin and a vinyl compound (I) defined below or a vinyl compound (II) defined below:
Vinyl compound (I): A vinyl compound represented by CH₂═CH.R, wherein the substituent R has a steric parameter Es of not larger than −1.64 and a steric parameter B1 of not smaller than 1.53;
Vinyl compound (II): A vinyl compound represented by CH₂═CH.R′, wherein the substituent R′ is a secondary alkyl group or a tertiary alkyl group.

2. The resin sheet according to claim 1, wherein a design layer and the resin layer are laminated together.

3. A thermoformed resin article obtained by thermoforming the resin sheet according to claim 1.

4. A laminate structure comprising the thermoformed resin article according to claim 3 and a substrate of a thermoplastic resin, the substrate being laminated to the thermoformed resin article.

5. The laminate structure according to claim 4, wherein the thermoplastic resin is a crystalline olefin polymer resin.

6. An automotive part comprising the laminate structure according to claim 4.

7. A part of household appliances, the part comprising the laminate structure according to claim 4.
